(19) United States
(12) Patent Application Publication
(10) Pub. No.: US 2008/0127009 A1
(43) Pub. Date: May 29, 2008

(54) METHOD, SYSTEM AND COMPUTER PROGRAM FOR AUTOMATED HARDWARE DESIGN DEBUGGING

(76) Inventors: ANDREAS VENERIS, Toronto (CA); Sean Safarpour, Toronto (CA); Moayad Yehia Fahim Ali, Sunnyvale, CA (US); Hratch Mangassarian, Toronto (CA)

Correspondence Address: MILLER THOMPSON, LLP, Scotia Plaza, 40 King Street West, Suite 5800, TORONTO, ON, M5H 3S1, omitted

(21) Appl. No.: 11/556,466

(22) Filed: Nov. 3, 2006

(51) Int. Cl. G06F 17/50

(52) U.S. Cl. 716/4

(57) ABSTRACT

The present invention provides a method, system and computer program for automated debugging for pre-fabricated digital synchronous hardware designs implemented in Hardware Description Language (HDL). Required information is captured by interacting with the verification environment after verification fails. This capture information is used to build a diagnosis problem where the solution is a set of logic level error sources. Using the HDL information, the error at the logic level is translated to gates, modules, statements, and signals in the HDL description. The diagnosis problem can be solved efficiently formulating a Quantified Boolean Formula (QBF) problem and also by using the hierarchical and modular nature of the HDL design during diagnosis.

### FIELD OF THE INVENTION

The present invention relates to the field of hardware debugging. The present invention more particularly relates to debugging hardware designs implemented in Hardware Description Language (HDL).

### BACKGROUND OF THE INVENTION

Hardware design debugging is the process of finding or locating errors in designs after verification methodologies and techniques determine the presence of such errors. Design debugging is considered a major bottleneck in the overall hardware design cycle which consumes over 30% of the design effort. Today, design debugging is performed almost exclusively manually by hardware designers and verification engineers using graphical navigation tools. This is a tedious, time consuming and costly manual process.

A typical hardware design cycle starts with a specification document which describes the functionality, timing and general constraints of the design. The specification is used to both create the design, typically implemented in Hardware Description Language (HDL), and to determine the expected behavior specified by the verification environment. HDL designs are most commonly implemented at the Register Transfer Level (RTL) using Verilog™ or VHDL. This approach to hardware design typically uses hierarchical and modular design concepts, where blocks or sub-designs are instantiated inside one another and connected together. Hierarchical and modular development is favored as it is ideal for design reuse, development in a large group, and for verification and debugging among others.

A typical verification environment is composed of a web of advanced tools, methodologies and techniques. Each verification component has a set of strengths and weaknesses which make it ideal of specific verification tasks. Popular verification approaches include the use of one or more of the following:
Simulation engines driven by testbenches (hand written or automatically generated). Known as the work horse of verification, simulation engines are used extensively to quickly test a wide range of input stimuli and find errors quickly. In practice, simulation engines can rarely be used to prove the correctness of a design.
Formal verification tools. Used to formally verify specific properties, corner cases, or equivalences with other designs or models. Due to their slow performance compared to simulation engines, they are employed to prove conformity of important properties.
Semi-formal tools. These use a combination of simulation and formal techniques to verify properties, corner cases and increase verification coverage. They balance the strengths and weaknesses of both approaches.

Each of the above approaches compares the design against a model derived from the specifications to determine whether the design demonstrates a correct or erroneous behavior.

If the verification methodologies and techniques determine that an error exists in the design (i.e. verification fails), then the design is debugged to find the exact error source. Debugging is a manual task where the verification engineer typically uses the erroneous response of the design, the expected behavior as stated by the specifications, and the input stimuli to determine what modules, gates, HDL statements or signals are responsible for the erroneous behavior. The manual debugging process typically starts by examining the erroneous primary outputs and tracing all suspect gates, signals, and modules backwards through the design. Graphical navigation tools can be used to ease the manual tracing process. Suspect components are those whose values appear to be inconsistent with those of the specifications. Needless to say, debugging is usually an ad-hoc process where the verification engineers' knowledge of the design and debugging experience play a major role in the efficiency of the process.

Once a suspect error source is found, the verification engineer attempts to correct the error and reruns the verification step to ensure that the problem has been rectified. In practice, finding the actual error source and correcting the problem is done in a trial-and-error manner where many iterations may be needed until the error is removed. FIG. 1 illustrates a verification and debugging process starting from a design specification.

One particular debugging approach was disclosed in U.S. Pat. No. 6,366,874 to Lee et al., which teaches a system and method for browsing graphically an electronic design based on a hardware description language specification. According to the technique, a user interacts with the system to browse or navigate through the design to find the error locations manually. However, the approach is not automated, requiring the constant input of a user. As well, the solution is tied to a particular graphical representation of the problem.

Other diagnosis methods have been proposed. For example, path tracing is a diagnosis technique that can be used find error source in a gatelevel representation of a design given a set of input/output vectors that demonstrate the erroneous behavior. (See: M. Abramovici, P. R. Menon, D. T. Miller, “Critical path tracing—an alternative to fault simulation,” in Proc. of Design Automation Conference, 1988, pp. 468-474.) This technique traverses the gatelevel circuit backwards starting at the primary inputs and identifies a set of gates that may be responsible for the erroneous behaviour.

Symbolic simulation (or BDDs) can be used as a means to diagnose erroneous gatelevel designs. (S. Huang, “Speeding up the Byzantine fault simulation using symbolic simulation,” in Proc. of VLSI Test Symposium, 2002, pp. 193-198.) The circuit and vectors are used to build a BDD which can be solved to find the gates responsible for the erroneous behavior.

Furthermore, SAT-based debugging solves the diagnosis problem by building a constrained satisfiability problem and uses a SAT solver to find solutions to the problem. (A. Smith, A. Veneris, M. F. Ali, and A. Viglas, “Fault diagnosis and logic debugging using Boolean satisfiability,” IEEE Trans. on CAD, vol. 24, no. 10, pp. 1606-1621, 2005.) The inputs to the problem are a gatelevel circuit and a set of vectors used to detect the error. The output is a set of gates that may be responsible for the erroneous behavior.

These are example of diagnosis methods and tools that work on the gate/logic level but do not extract capture information from the HDL level and do not translate the results back to HDL. These approaches are different from a hierarchical approach because they only work on the gatelevel (or logic level) and do not consider modular or hierarchical information. In addition, these known techniques do not implement a Quantified Boolean Formula (QBF) approach.

### SUMMARY OF THE INVENTION

The present invention provides a method, system and computer program for automated hardware design debugging.

In one aspect, the present invention is a method that is best understood as a three step process whereby: (i) information required to perform a diagnosis, referred to as “Capture Information”, is retrieved via interaction with a verification environment; (ii) once the Capture Information is available, a diagnosis problem is constructed that is solvable using one or more techniques; and (iii) a logic-HDL map is used to translate solutions of the diagnosis problem to the HDL-level where the user can identify the one or more error sources.

According to one embodiment, the diagnosis problem is formulated as a Quantified Boolean Formula (QBF), allowing large designs to be handled in a memory efficient manner. The QBF approach can accommodate formulation for multiple capture and/or multiple time frames. Furthermore, the method of the present invention can be modified to take account of the hierarchical and modular nature of HDL designs.

In another aspect, the present invention is a computer software program used to automatically find the source of errors in pre-fabricated synchronous integrated circuit designs that fail verification, utilizing the method steps provided above.

In yet another aspect, the present invention is a system consisting of a computer that includes the computer software program, such that the computer is operate to automatically find the source of errors in pre-fabricated synchronous integrated circuit designs, based on the method steps provided above.

Advantageously, the present invention requires limited user interaction and is therefore distinguishable from existing manual debugging processes.

### BRIEF DESCRIPTION OF THE DRAWINGS

A detailed description of the preferred embodiments is provided herein below by way of example only and with reference to the following drawings, in which:

FIG. 1 illustrates a verification and debugging process;

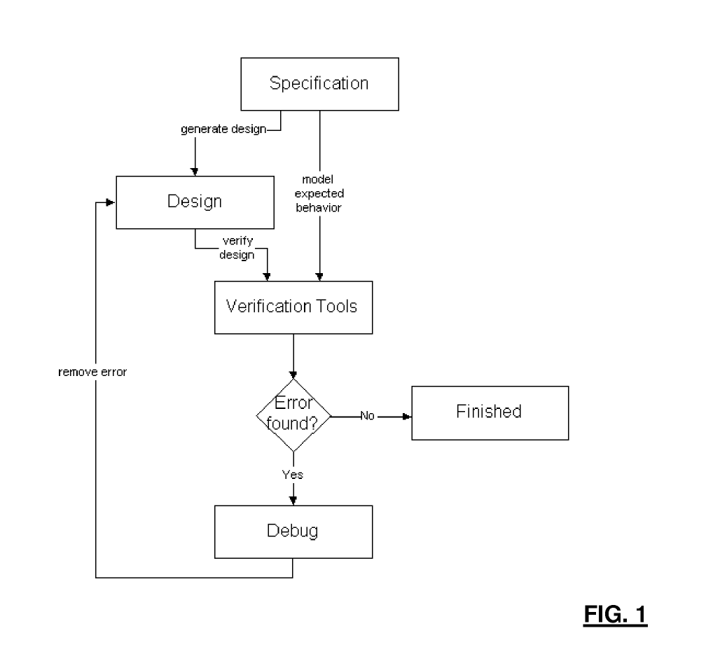

FIG. 2 illustrates a self-checking testbench;

FIG. 3 illustrates a self-checking testbench with capture block;

FIG. 4 illustrates inserting MUX error models into the constraint satisfaction problem;

FIG. 5 illustrates a constraint satisfaction problem for k time frames;

FIG. 6 illustrates QBF construction for multiple capture;

FIG. 7 illustrates QBF construction for multiple time frames;

FIG. 8 illustrates an example of hierarchical diagnosis procedure for 2-bit adder;

FIG. 9 provides mult_top.v, mult_adder.v and mult_tb.v Verilog™ files; and

FIG. 10 provides mult.vcd Verilog™ file.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The present invention provides an automated hardware design debugging approach implemented as a method, system and computer program.

Generally speaking, the overall process of finding the source of errors in a design at the HDL level is referred to as “debugging” and the process of locating the error sources at the gatelevel and logic level is referred to as “diagnosis”.

The present invention first interacts with the verification environment and retrieves information required to perform diagnosis. This is referred to as the “Capture Information”. Once the Capture Information is available, a diagnosis problem is constructed which can be solved using existing techniques or new techniques, as described herein. Finally, a logic-HDL map is used to translate solutions of the diagnosis problem to the HDL-level where the user can identify the error sources.

This automated debugging approach is different from the existing manual debugging processes described above because limited user interaction is required which makes the present invention substantially automated.

### 1. Extracting Capture Information

Extracting the Capture Information from the verification environment is important to formulating and solving the diagnosis problem. As discussed above, the verification environment can include a simulation engine, a formal verification tool or a combination thereof. The Capture Information includes but is not limited to the following:
The input stimuli used by the simulation engine or provided by the formal verification tool to detect the errors. Depending on the verification tool used and the context, these are also called a simulation trace, a counterexample, or a test vector. In the following, we call these “debuggerInputs”.
The clock used by the digital synchronous design, called “debuggerClk”.
A “debuggerCapture” signal that identifies the beginning and end of the simulation trace. When debuggerCapture is high (debuggerCapture=1) it states that the input stimuli and other signals of interest are captured. This signal is generated by the verification engineer and does not necessarily exist in the design.
Initial state values are the values stored in the registers and memory elements (flip-flops, latches, etc.) when debuggerCapture makes a transition from low to high. In the following, these initial state values are called “debuggerStates”. This information is not required, but can benefit the diagnosis process.
The expected output values specified by the specifications, also called the “debuggerOutputs”. There are many different ways to implement the expected values such as in a golden model implemented in HDL or in software, in a property description or an assertion statement. Irrespective of how the expected value is specified, there is always a correspondence between the expected values and the output of the design. In some cases the correspondence is obvious while in others the verification engineer helps to extract the information.
Optional Capture Information may include (but not limited to) reset, enable or other controlling signals, as well as assertion or property values relating to internal circuit signals.

Most formal verification tools have accessor functions and features that allow users to extract values for specific signals. Thus, extracting the above signals can be done relatively easily in formal tools.

The following example illustrates how the above information is extracted from a simulation engine. Although simulation engines are one of the most popular verification approaches, it should be understood that the present invention is not limited to the verification approach in this example.

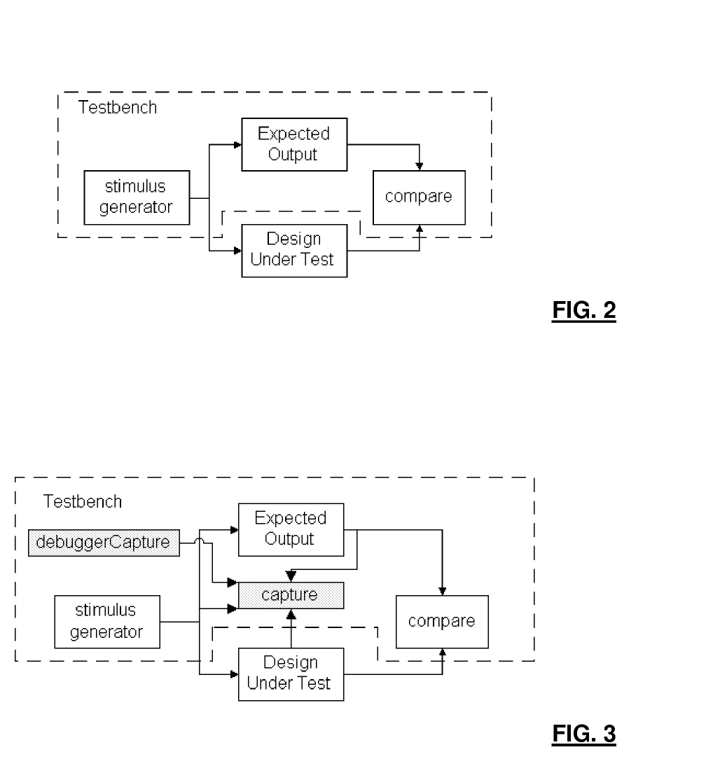

Example. Consider the self-checking testbench illustrated in FIG. 2. The testbench generates stimulus to input the Design Under Test (DUT) and checks the output of the DUT against the expected output specified by specification. The simulation engine simply follows the testbench instructions as it applies the stimulus, simulates the DUT and compares the outputs. If the outputs are different, then the testbench instructs the simulator to halt and convey to the user that an error has occurred.

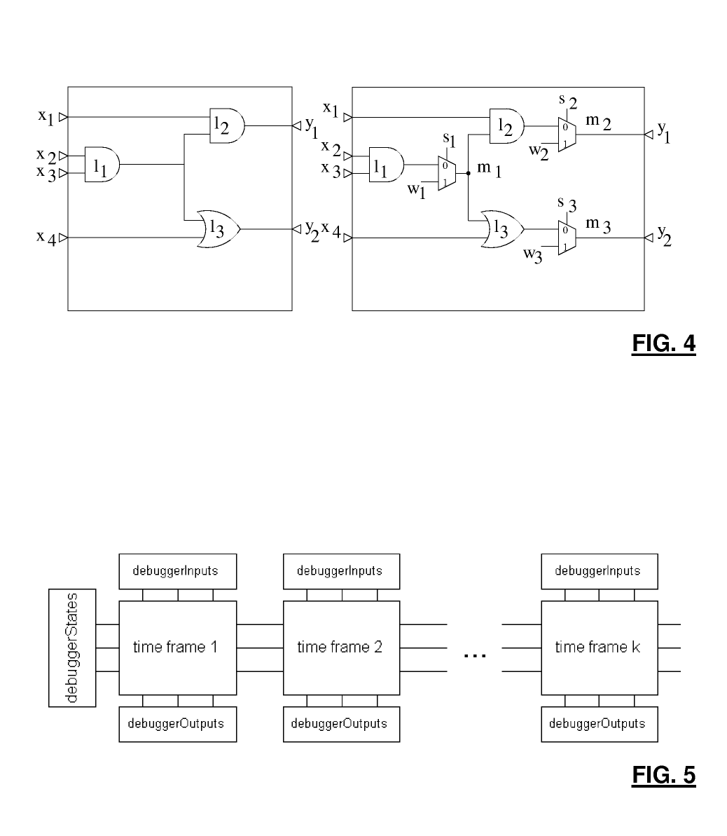

To enable automated debugging, the Capture Information described earlier is extracted by slightly modifying the testbench. Conceptually this leads to a new block in the testbench that retrieves the values of debuggerInputs and debuggerClk from the stimulus generator block, debuggerStates from the DUT, and debuggerOutputs from the expected output block. The signal debuggerCapture is generated separately by the verification engineer. FIG. 3 illustrates how the testbench is modified to retrieve the Capture Information.

In an HDL testbench such as Verilog™, the Capture Information can be collected and stored in a Value Change Dump (VCD) file format using the “$dumpvars” command. For instance, after assigning all inputs, expected outputs, clock and memory elements to their corresponding variables and generating the debuggerCapture signal, the $dumpvars command would look like:

$dumpvars (0, debuggerInputs, debuggerClk,
debuggerOutputs, debuggerStates, debuggerCapture);

At the end of the simulation, a file specified by “$dumpfile” contains the Capture Information in VCD format.

Some testbenches include many individual tests where different sequences of stimuli drive the DUT and check for correctness. For each individual test that fails verification within the testbench, the Capture Information can be extracted when the debuggerCapture signal is asserted. As such, it is possible to generate more than one set of Capture Information from a single testbench. The more Capture Information is available, the better the debugging result may be as few potential error sources will be found.

### 2. Constructing the Diagnosis Problem

Once the Capture Information is available, there is enough information to use known diagnosis techniques to solve the debugging problem. Diagnosis techniques use a set of input vectors, output vectors and a design at the logic or gatelevel to try to identify the inconsistencies between the output of the design and the output vectors. Some popular techniques use simulation and path tracing methods, Binary Decision Diagram (BDDs), or reformulate the problem as a constraint satisfaction problem.

As stated previously, constraint satisfaction is one method of solving the diagnosis problem where the aim is to find a satisfying assignment to the former which leads to a solution to the latter. Generally speaking, constraint satisfaction problems can be solved using many different known approaches. Some popular techniques are list below.
Boolean Satisfiability (SAT) solver. These solvers use branching and resolution techniques to find a satisfiable assignment to the problem variables. (See for example: J. Marques-Silva and K. Sakallah, “GRASP: a new search algorithm for satisfiability,” in Int'l Conf. on CAD, 1996, pp. 220-227.)
Binary Decision Diagrams (BDD). These data structures formulate the problem in canonical manner and find a satisfying assignment by traversing the BDD graph. (See for example: R. Bryant, “Graph-based algorithms for Boolean function manipulation,” IEEE Trans. on Comp., vol. 35, no. 8, pp. 677-691, 1986.)
Quantified Boolean Formula (QBF) solvers. These solvers are similar to SAT solvers except that they can solve more general satisfaction problems where some variables are universally quantified in the problem. (See for example: M. Benedetti, “sKizzo: a Suite to Evaluate and Certify QBFs,” in Proc. of 20th International Conference on Automated Deduction (CADE05), 2005, pp. 369-376.)
Automatic Test Pattern Generation (ATPG) and branch-and-bound search techniques. These approaches search the problem space according to the problem structure and heuristics to find a satisfying assignment. (See for example: M. Abramovici, M. Breuer, and A. Friedman, Digital Systems Testing and Testable Design. Computer Science Press, 1990.)

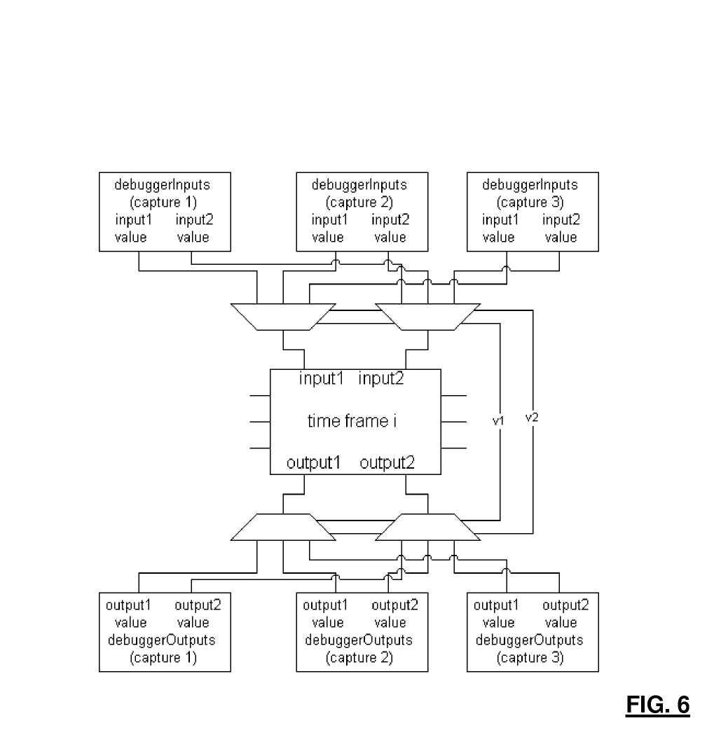

The constraint satisfaction problem is generally formulated mathematically according to the following steps (hereinafter the “constraint satisfaction steps”):
1. Translating the erroneous digital synchronous circuit from its HDL representation (either at the RTL or gatelevel) into a mathematical model. This step can be performed by existing HDL synthesis tools which iteratively break HDL statements into series of gates or logic that implement the required functionality. For the SAT and QBF approaches, this model is further converted to Conjunctive Normal Form (CNF). For BDD approaches, the gate representation is converted to BDDs while ATPG and other search methods work on a logical or graph-based model.
   a) These mathematical models only represent the combinational component of the circuits. The sequential components (i.e. flip-flops, latches, etc.) are removed and their input and outputs are replaced with current state and next variables, respectively. This process is often called converting a circuit into its “full-scan” representation.
2. Inserting error models into the mathematical circuit model to represent the error locations.
   a) These models (s₁,s₂ . . . ,sₙ) can be added to every variable (or circuit line depending on the circuit model used) or a subset of the variables. From the circuit point of view, these can be multiplexers (MUX), where the 0-input of the MUX is connected to the original variable and the 1-input of the MUX is connected to the a new primary input (unconstrained variable). The output of the MUX is connected to the fanouts of the original variable and the select lines are left unconstrained (s₁,s₂ . . . ,sₙ). FIG. 4 gives an example of how the MUX error models are added to a gatelevel circuit representation.
   b) The MUX error model can be formulated as logic or in CNF. A CNF representation of the model for the original variable l, the fanout variable w, and a multiplexer select line s is (where l′ and w′ are the inverted variables l and w, respectively):

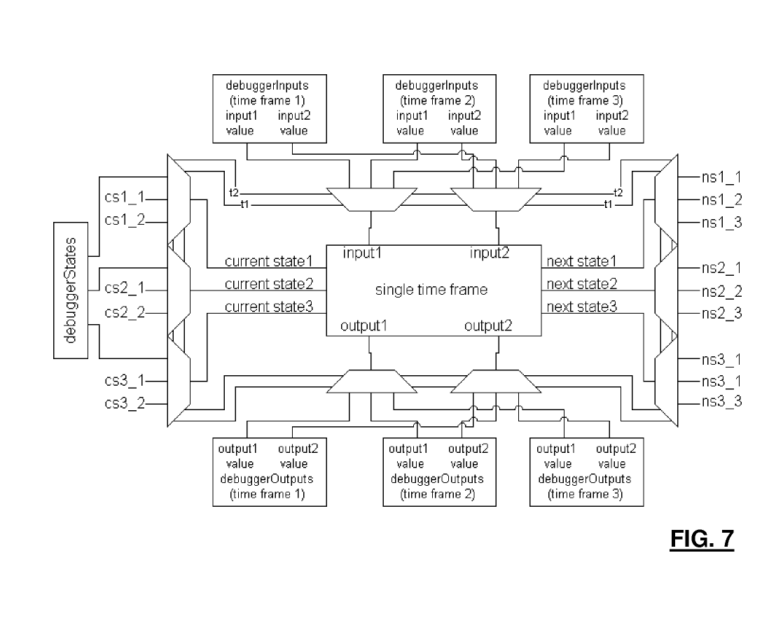

(l+s+w′)·(l′+s+w)
c) Other representations having the same behavior as a) and b) exist for this error model.
d) Error models may be added to a subset of the variables. For example, in hierarchical or modular debugging techniques, the error models are only added to the output of modules at each stage of the design hierarchy. Adding error models on a subset of the variables can increase the debugger efficiency and overall effectiveness.
3. The constraint satisfaction problem is constrained to only allow N error sources to be active at one time. This allows the diagnosis framework to be run iteratively with N=1,2,3 . . . until error sources are found. This constraint is called the Error Cardinality Constraint (ECC) and can be implemented using many different techniques such as adder-comparator circuits, or sorter circuits. For instance, the adder-comparator circuit takes as input the error model variables (s₁,s₂ . . . ,sₙ) adds these together to get an integer N′ which is forced to be equal to N. The ECC block can be converted to CNF using existing techniques (see: A. Smith, A. Veneris, M. F. Ali, and A. Viglas, “Fault diagnosis and logic debugging using Boolean satisfiability,” IEEE Trans. on CAD, vol. 24, no. 10, pp. 1606-1621, 2005).
4. For each of the k clock cycles in the debuggerClk signal the model in step 2 is replicated or unfolded into k time frames. Each time frame is modified such that its current state variables are connected to the next state variables of the previous time frame. This construction is also known as the Iterative Logic Array (ILA).
5. The input stimulus values stored in debuggerInputs and the expected output values stored in debuggerOutputs are applied to the corresponding variables and time frames in the iterative logic array model of step 2. For the SAT and QBF approaches, these values are applied using unit literal clauses. In the BDD approach, edges in the graph corresponding to the opposite values are removed thus simplifying the graph. In the ATPG and other search methods, constant constraints are added to the problems. Similarly, the initial state values stored in debuggerState are applied to the current state variables of the first time frame only.
6. The overall constraint problem of step 15 can be solved using many different approaches such as SAT and QBF solvers and BDDs. FIG. 5 represents the entire constraint satisfaction for k clock cycles.
7. To guarantee that the error sources are found by the diagnosis tool, all the possible solutions to the constraint satisfaction problem are found. This is accomplished by iteratively running step 6 and searching for different solutions until no more solutions exist. For example, in the SAT approach this task can be accomplished by adding a clauses or constraint to the problem after a solution is found to prevent the solution from be found again.

### 3. Translating Results to the HDL-Level

The result of the diagnosis approaches described above is a set of potential error sources at the logic or gate level that may explain the inconsistencies between the HDL design and the specifications. This information, albeit valuable, may not provide much insight to the designer. For maximum effectiveness, the error sources are translated to the design entry level that the designer is familiar with. In other words the logic level error sources are translated to the HDL level.

A logic to HDL (Logic-HDL) map is created in step 1 of the constraint satisfaction method steps. In this step, every HDL statement is systematically broken into the logic functions that it implements. This process is known as HDL synthesis. During HDL synthesis, every variable at the logic level is added to a hash-like data structure that relates it to its source(s) at the HDL. Sources at the HDL level are statements that specify the function of a given variable. Further information such as the module's parent or encapsulating modules (children), the file name, and the line number of the HDL statement are also stored in the data structures.

When diagnosis tools, such as those described above, return logic level error sources, these logic level variables are translated to their corresponding statements at the HDL level using the Logic-HDL map. The final result of this step is a set of HDL statements, modules, files, and line numbers that are potential sources of errors.

This information may be simply presented as above or displayed in a graphical manner. For example, a hierarchical tree structure where potential erroneous modules and gates are highlighted with different color may provide more insight. Similarly, the potential erroneous HDL statements can be highlighted for quick identification.

Example. Consider a simple four bit adder (four_adder) implemented as four 1-bit adder modules (adder) in Verilog™ HDL as shown below. When this design is translated to the gate level, each variable is inserted in the Logic-HDL map. For instance, the variable out[0] is mapped to HDL statement:
assign out=in1̂in2̂cin;
   in the file adder.v on line 5 and the statement
adder a1(in1[0], in2[0], cin, out[0], c[0]);
   in file four_adder.v on line 9. Similarly, the variable c[2] is mapped to HDL statements in the file adder.v on line 6 and the file four_adder.v on line 11.
FILE: adder.v
1 module adder(in1, in2, cin, out, cout);
2 input in1, in2, cin;
3 output out, cout;
4
5 assign out=in1̂in2̂cin;
6 assign cout=(in1 & in2)|(in1 & cin)|(in2 & cin);
7
8 endmodule
FILE: four_adder.v
1 module four_adder(in1, in2, cin, out, cout);
2 input [3:0] in1, in2;
3 input cin;
4 output [3:0] out;
5 output cout;
6
7 wire [2:0] c;
8
9 adder a1(in1[0], in2[0], cin, out[0], c[0]);
10 adder a2(in1[1], in2[1], c[0], out[1], c[1]);
11 adder a3(in1[2], in2[2], c[1], out[2], c[2]);
12 adder a4(in1[3], in2[3], c[2], out[3], cout);
13
14 endmodule

### Improving Diagnosis

Specific steps described above can be modified to achieve better performance results for overall debugging. First, the formulation of the diagnosis problem as a Quantified Boolean Formula (QBF) is introduced. The QBF formulation allows large designs to be handled in a memory efficient manner. Second, the diagnosis formulation is adapted to use the hierarchical and modular information of HDL designs to help locate errors more efficiently.

### QBF Formulation for Multiple Capture

As mentioned above, it is possible to have more than one set of Capture Information from a single testbench. It is also possible to derive Capture Information from a combination of different verification techniques such as simulation engines and formal verification tools. For instance, four sets of Capture Information may be extracted from two different testbenches while three other sets of Capture Information are extracted from formal verification tools. The result is that there are seven sets of Capture Information that can be used to debug the problem by constructing the problem as described above.

Taking into account all the Capture Information has the benefit of reducing the number of potential error sources found by the diagnosis tool and may also increase the efficiency of the diagnosis tool as the problem search space is reduced.

One way of using all the Capture Information is to follow the constraint satisfaction method steps for each capture set and intersect the results of each diagnosis run. A similar approach is to diagnosis each capture set iteratively but only add error models (i.e. step 2 of the constraint satisfaction steps) on the locations found as potential error locations during previous diagnosis runs.

Another way of using all the Capture Information is to construct a single constraint satisfaction problem. Since the solution to the entire diagnosis problem is valid if-and-only-if it is a solution for each capture set, the conjunction of each problem results in a single diagnosis problem. For example, if the constraint satisfaction problem is given in CNF with Φ₁ and Φ₂ representing Capture Information 1 and 2, respectively, then the single CNF problem for both capture sets is the conjunction Φ₁·Φ₂.

The implementation details of this aspect of the present invention are as follows.

The constraint satisfaction problem for multiple capture sets can be formulated as a Quantified Boolean Formula (QBF) satisfiability problem. A QBF problem is one where a Boolean propositional formula Φ is satisfied given that some variables are existentially or universally quantified. The QBF formulation for the constraint satisfaction problem with multiple capture sets is

∃s₁s₂ . . . sₙ ∀v₁v₂ . . . vₘφ.

This formula states that for that there exists a set of error model variables s₁,s₂ . . . ,sₙ such that for all the capture sets v₁,v₂ . . . ,vₘ the formula Φ holds. As in the SAT formula described above, the error model variables (s₁,s₂ . . . ,sₙ) represent the potential error sources. These are the solutions to the QBF problem which are also solutions to the diagnosis problem. One major advantage of the QBF formulation is that it requires only a fraction of the memory of the SAT approach and thus provides large memory saving when there are many capture information.

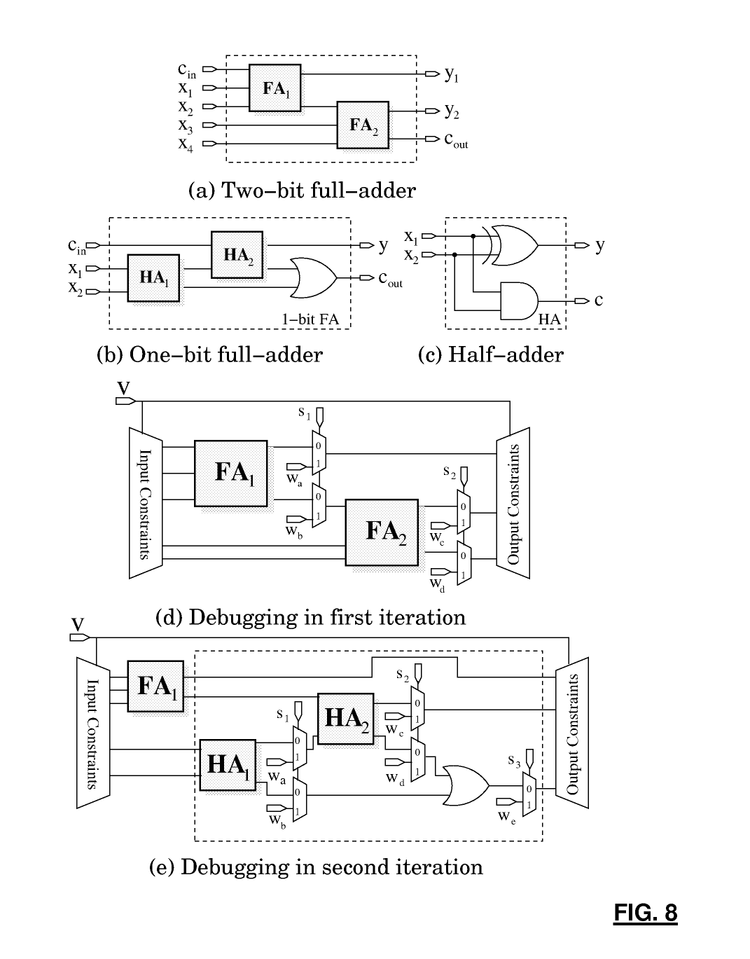

The Boolean propositional formula Φ is derived by following method steps 1 to 4 described above and adding more extra logic/circuitry to the ILA formulation. The extra logic represents all the capture values that are considered, which is modeled using L conditional clauses in CNF or by an L-input multiplexer (L-MUX) and L-demultiplexers (L-DEMUX) in circuit. The following steps (hereinafter the “QBF formulation for multiple capture steps”) describe how the extra logic is added to the problem formula Φ using the circuit representation (which can be translated to CNF using existing techniques):
1. Let k be equal to the largest number of clock cycles (from debuggerclk) in all the capture sets and let c be equal to the number of distinct Capture Information.
2. Add an L-MUX for each circuit input and an L-DEMUX for each circuit output for each time frame in an ILA of size k, where L=2^{ceiling(log}₂^{(c))}. The output of each L-MUX is connected to an input variable, while each of the L inputs of the L-MUX are connected to the debuggingInputs values of each capture set in each time frame (L-MUX input i is connect to the input value for capture i). Similarly, the input of each L-DEMUX is connected to an output variable while the output of the L-DEMUX is connected to the debuggerOutputs values for each vector in each time frame. FIG. 6 illustrates the QBF formulation of ILA model described above for a single time frame with two inputs and two outputs and three distinct capture sets. The select lines of the L-MUX and L-DEMUX are labelled v1 and v2 and are all tied together.
3. Add an L-MUX for each initial state variable in the circuit where L=2^{ceiling(log}₂^{(c))}. The output of each L-MUX is connected to an initial state variable and each L-MUX input is connected to the debuggerStates values for each capture. The L-MUX select lines are the same as those in step 2.
4. Since 2^{ceiling(log(c))} may be larger than the number of Capture Information c, the L-MUX and L-DEMUX inputs and outputs that are unspecified (constrained) from the capture set can remain unconstrained, respectively. In other words, no clauses need be added to the problem CNF for the last 2^{ceiling(log}₂^{(c))}−c variables for each capture. This situation is illustrated in FIG. 6, as there are 2 select variables (v1 and v2) which can select up to 4 capture sets, but there are only 3 capture sets available. In turn, the 4^{th} set of values are unconstrained and not shown in FIG. 6.
   a) In some cases, it may be beneficial to add constraints to these last 2^{ceiling(log}₂^{(c))}−c variables to increase the performance of the QBF solver. However, only satisfiable constraints will work. For instance, the input values can be constrained to the logical 0 value and the outputs can remain unconstrained to improve the QBF performance.
5. Some capture sets may have less clock cycles than others in the debuggerClk. Since the ILA is constructed for the longest clock cycles in the capture set, some inputs of the L-MUX and outputs of the L-DEMUX will be unconstrained for the time frames where some capture sets have less than k clock cycles. These unconstrained variables can be treated similar to step 4.
6. The overall QBF problem for formula Φ described in steps 1-5 is given as

∃s₁s₂ . . . sₙ ∀v₁v₂ . . . v_{log}_{₂}_{(c)}φ

where s₁,s₂ . . . ,sₙ are error source models and v₁,v₂ . . . ,v_{log}_{₂}_{(c)} are the L-MUX and L-DEMUX select lines.
7. The QBF problem of step 5 can be solved by any QBF solver to find a potential error source as determined by the values of s₁,s₂ . . . ,sₙ variables. Similar to the SAT problem described above, to get all potential error sources the problem is solved iteratively to find new solutions and prevent previous solutions from recurring.

### QBF Formulation for Multiple Time Frames

Similar to the description of QBF formulation for multiple capture, the ILA model described above can be reformulated as a QBF problem where time frames are not required. The benefits are that the QBF problem needs much less memory than the SAT approach as the problem need not be replicated as in the ILA model.

The implementation details of this aspect of the present invention are as follows.

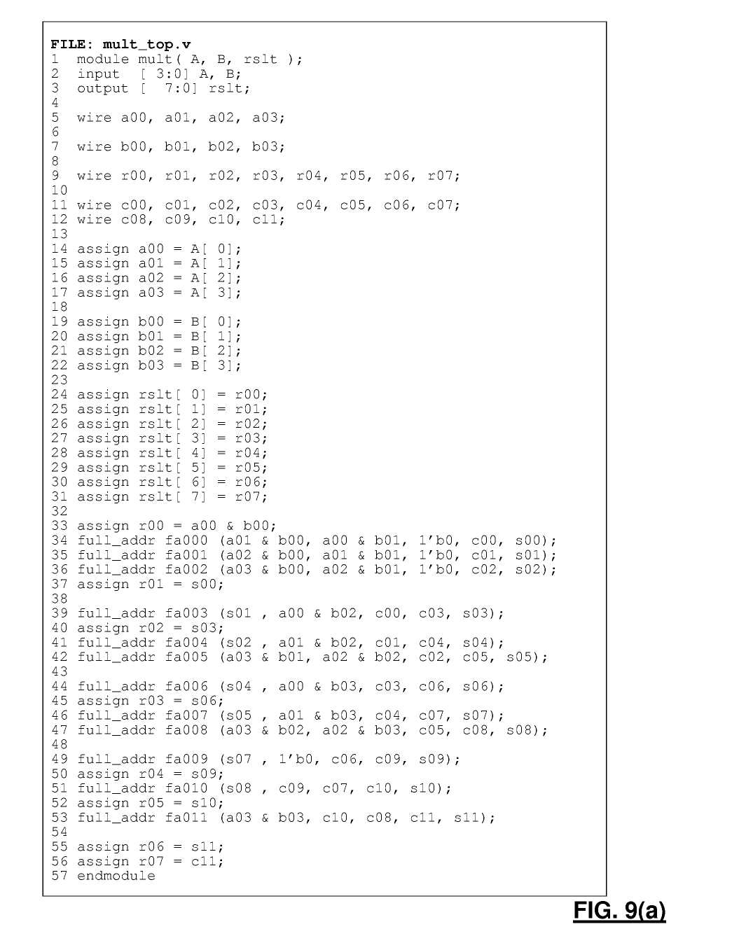

To construct the Boolean propositional formula Φ for the QBF diagnosis problem when time frames are not replicated, steps 1-3 of the constraint satisfaction steps are followed by the steps below (hereinafter the “QBF formulation for multiple time frame steps”). Note that the QBF formulation for multiple time frame steps assume a single capture set, wherein the QBF formulation for multiple capture steps can be used for multiple Capture Information.
1. Let k be equal to the number of clock cycles (from debuggerclk).
2. Add an L-MUX for each circuit input and an L-DEMUX for each circuit output, where L=2^{ceiling(log}₂^{(k))}. The output of each L-MUX is connected to an input variable, while each of the L inputs of the L-MUX are connected to the corresponding debuggerInputs values for each time frame (L-MUX input i is connected to time frame i. Similarly, the input of each L-DEMUX is connected to an output variable while the output of the L-DEMUX is connected to the corresponding debuggerOutputs values for each time frame.
3. Add an L-MUX for each current state variable and an L-DEMUX for each next state variable, where L=2^{ceiling(log}₂^{(k))}. The output of each L-MUX is connected to a current state variable j, while each input i+1 of the L-MUX is connected to a non-constrained variable csi_j. Similarly, the input of each L-DEMUX is connected to a next state variables j, while each output i of the L-DEMUX is connected to a non-constrained variable nsi_j. There is an exception to above, where the current state variables 1 are constrained to the debuggerStates values since these represent the initial state constraints. FIG. 7 illustrates the QBF construction for a capture set with three clock cycles where the L-MUX and L-DEMUX select variables are labeled t1 and t2.
4. Dealing with the case where L is larger than k is exactly as in step 4 for QBF formulation for multiple capture, provided previously.
5. Connect the current state and next state variables together. This can be done by adding a wire between the state variable csi_j to next state variables nsi_j for time frame i and state variable j. Alternatively, two clauses of the form

(csi_{—}j+nsi_{—}j′)·(csi_{—}j′+nsi_{—}j)
can be added directly to the CNF (where nsi_j′ and csi_j′ are complements of nsi_j and csi_j′ respectively).
6. The previous steps construct the Boolean propositional formula Φ, the overall QBF problem is state as

∃s₁,s₂, . . . , sₙ, ns1_{—}1, ns1_{—}2, . . . , nsj_k∀t₁,t₂, . . . , t_{log}_{₂}₍ₖ₎φ
where s₁,s₂ . . . ,sₙ are the error models, ns1_{—}1,ns1_{—}2, . . . ,nsj_k are the next state variables for j state variables and k time frames, and t₁,t₂ . . . t_{log}_{₂}₍ₖ₎ are the L-MUX and L-DEMUX select lines.
8. The QBF problem of step 6 can be solved by any QBF solver to find a potential error source as determined by the values of s₁,s₂ . . . ,sₙ variables. Similar to the SAT problem above, to get all potential error sources, the problem is solved iteratively to find new solutions and prevent previous solutions from recurring.

### QBF Formulation for Multiple Time Frames and Capture

The QBF formulations for multiple capture and multiple time frame described above can be combined to result in a single QBF problem for both multiple time frames and multiple Capture Information. The main difference is that the Boolean propositional formula Φ is obtained for multiple time frames using steps 1-5 for QBF formulation for multiple time frames and then following steps 1-4 for QBF formulation for multiple capture. The overall QBF problem for the resulting propositional formula Φ is

∃s₁,s₂, . . . ,sₙ∀v₁,v₂, . . . ,v_{log}_{₂}_{(c)}∃ns1_{—}1,ns1_{—}2, . . . ,nsj_k∀t₁,t₂, . . . ,t_{log}_{₂}₍ₖ₎φ

where s₁,s₂ . . . ,sₙ are the error models, v₁,v₂ . . . , v_{log}_{₂}_{(c)} are the MUX and DEMUX select lines for multiple capture sets, ns1_{—}1,ns1_{—}2, . . . ,nsj_k are the next state variables for j state variables and k time frames, and t₁,t₂ . . . , t_{log}_{₂}₍ₖ₎ are the MUX and DEMUX select lines for the multiple time frames.

### Hierarchical Diagnosis

The hierarchy and modular nature of HDL designs can help improve the performance and quality of diagnosis tools such as critical path tracing, symbolic simulation and constraint satisfaction. The diagnosis procedures described above can therefore all be slightly modified to take account of the hierarchical and modular information during the debugging.

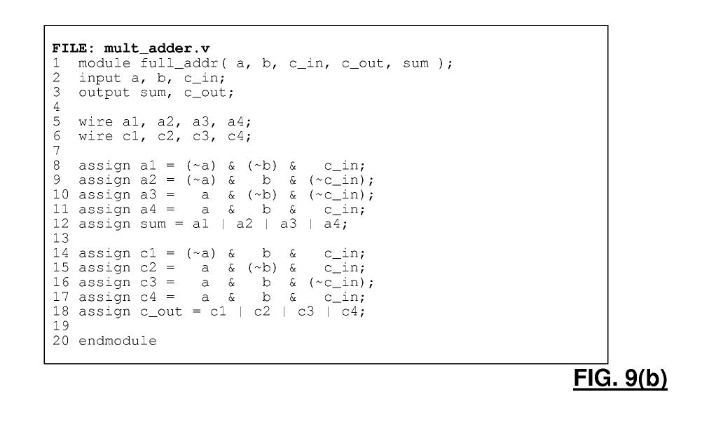

The hierarchical procedure finds potential error sources in the design by following the design hierarchy and considering only modules or blocks as potential error sources. In this context an HDL module is defined as any HDL statement or any HDL instance that may or may not include other modules inside it. When an HDL design is translated to its logic-level or gatelevel representation, modules can be represented as boxes encapsulating sets of logic/gates. This definition also views individual gates as modules. Inputs to modules are signals from outside the module that are inputs to gates inside the module. Similarly, module outputs are outputs of gates within the modules which are inputs to gates outside the module. FIG. 8(a), illustrates a simple 2 bit full-adder where each full adder, each half-adder, and each gate is a module as shown in FIG. 8(b) and FIG. 8(c), respectively.

Each module of a design can be visited in a hierarchical manner by starting at the top-level module (the module that is not contained by any other) and iteratively visiting each module's sub-modules. This process is used by the hierarchical diagnosis tool by only considering the sub-modules of some current module as likely error sources. The following steps perform hierarchical diagnosis.
1. Set the current module to be the top-level module.
2. Build the SAT or QBF diagnosis problems by following the constraint satisfaction steps, the QBF formulation for multiple capture steps, or the QBF formulation for multiple time frame steps, except for step 2 of the constraint satisfaction steps which is replaced by step 3 below.
3. Insert error models into the mathematical circuit model to represent the error locations by only adding them to the outputs of the sub-modules of the current module(s). The select lines of the error models s₁,s₂ . . . ,sₙ are all tied together if they are all output of the same sub-modules.
4. The constraint satisfaction is solved as described above resulting in solutions in terms of the error models s₁,s₂ . . . ,sₙ.
5. The set of potential error models s₁,s₂ . . . ,sₙ that are activated (=1) and recorded. The current modules are updated to be the modules with their select lines activated.
6. If the current modules are the lowest level modules (i.e. they do not contain any sub-modules), then the process terminates. Otherwise, go back to step 2.

The results of the above procedure are a set of logic-level or gatelevel error sources as well as a set of modules that were visited during the diagnosis process. If gatelevel errors are not required, this process can be terminated early with error sources provided only as modules.

Example. Consider the hierarchical design of a two-bit full-adder in FIG. 8(a). This full-adder is comprised of two one-bit full-adders (FIG. 8(b)) each of which contains two half-adders shown in FIG. 8(c). Assume that the design error is the inversion of the output of the AND gate in the first half-adder (HA₁) of FA₂. A verification tool provides two capture sets with the first debuggerInput and debuggerOutput being (cᵢ,x₁,xᵢ₂,x₃,x₄,y₁,y₂,cₒᵤₜ)=(00011001) and the second being (cᵢ,x₁,xᵢ₂,x₃,x₄,y₁,y₂,cₒᵤₜ)=(00100100).

FIG. 8(d) illustrates the problem construction during the first hierarchical diagnosis iteration when the current module is the top-level module. Note that all multiplexers representing the error model are placed at the outputs of each full-adder and they share a common select line.

Let Φ₁ denote the corresponding CNF for this hardware, including the error cardinality constrain (not shown here), and the set of unit-literal clauses used to apply the set of debuggerInput and debuggerOutput.

The QBF problem for this iteration is stated as follows:

∃s₁,s₂∀vφ₁.

For N=1, the QBF solver returns the solution (s₁,s₂)=(0,1), indicating that the erroneous module at this hierarchy level is FA₂.

In the second iteration, multiplexers representing the error models are placed at the outputs of the half adders HA₁ and HA₂ of the erroneous module FA₂ and that of the OR gate. FIG. 8(e) illustrates the construction resulting in the formula Φ₂ leading to the QBF instance

∃s₁,s₂,s₃∀vφ₂.

This QBF instance has two distinct solutions. The first is (s₁,s₂,s₃)=(1,0,0) indicating that an error exists in module HA₁ while the other is (s₁,s₂,s₃)=(0, 0, 1) to suggest an error at the OR gate of module FA₂. After one more iteration, the AND gate of module HA₁ in FA₂ is also found as an error source. Thus, the trace of erroneous modules include FA₂, HA₁, the OR gate in FA₂ and the AND gate of HA₁ in FA₂.

### Debugging System Example

The following describes an example of the overall debugging system with emphasis on the overall process without going into the details of the diagnosis engines and constraint satisfaction solvers.

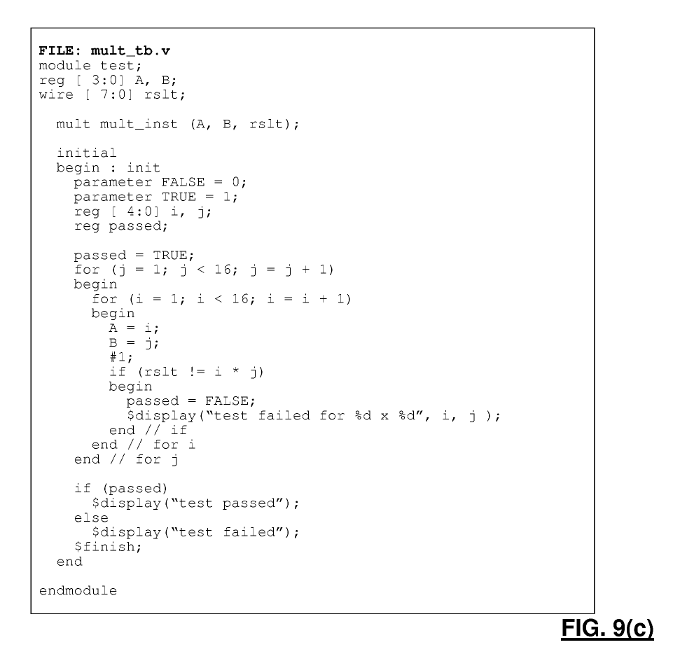

Consider a simple HDL design called mult implemented in two Verilog™ files mult_top.v and mult_adder.v. Further consider a testbench called test implemented in a Verilog™ file called mult_tb.v that instantiates the mult design and generates stimulus for the two inputs A and B ranging from 1 to 15. These files are shown in FIG. 9(a), 9(b) and 9(c), respectively.

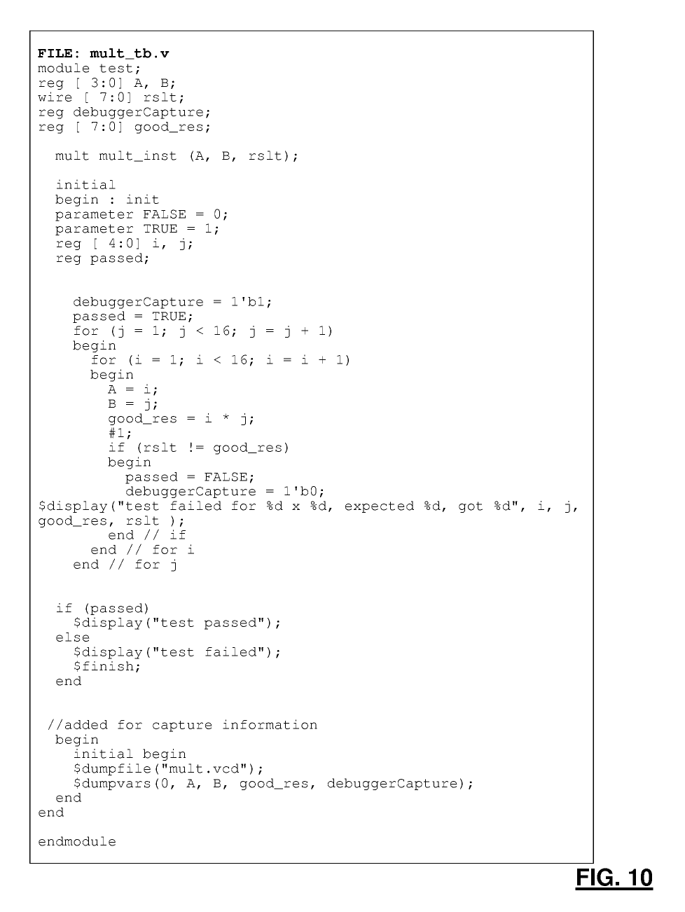

As explained in above, the Capture Information is extracted from the testbench to record the value of the debuggerInputs, debuggerOutputs, debuggerClk, debuggerStates, and debuggerCapture signals. As a result, the testbench is modified to extract the expected output (good_res), generate the debuggerCapture signals, as well as to record the values in the mult.vcd file as shown in FIG. 10. Note that this simple design is not sequential and therefore does not have/need the debuggerClk and debuggerState signals. The following is the mapping between signals and the Capture Information.
Signals A and B are mapped to debuggerInputs
Signal good_res is mapped to debuggerOutputs
Signal debuggerCapture is mapped to debuggerCapture

Assume that the error in the design is in the mult_adder.v file on the line 12:
assign sum=a1|a2|a3|a4;
   where the designer accidentally typed:
assign sum=a1|a2|a3|a3;

In this case, an erroneous behavior is first observed when simulating the testbench and design when the inputs are A=3 and B=7 and the output is rslt=17, while the correct/expected outcome is good_res=21. This Capture Information is easily derived from the file dump file mult.vcd.

The Capture Information above for the trace where A=3, B=7, and good_res=21 is used to build a diagnosis problem as described above. At this point, many known diagnosis techniques such as those described herein can be used to solve the problem. For this example, a QBF-based diagnosis technique is not used because there is only one trace and only one clock cycles because the circuit is combinational. Therefore the QBF formulation will be identical to the SAT formulation.

A hierarchical diagnosis approach can be used to efficiently find which modules are erroneous. At the top level, the module mult has 12 sub-modules of type full_addr (such as full_addr fa000(a01 & b00, a00 & b01, 1′b0, c00, s00);) along with many modules made up of single gates (such as assign r00=a00 & b00;)

The hierarchical and modular information from the HDL design can be used by the hierarchical diagnosis tool as explained previously. In the first iteration of the hierarchical diagnosis tool, only the submodules of the toplevel module are considered as potential erroneous modules. In this step, the diagnosis tool returns module fa003 as one of the erroneous modules because it is one of the modules in mult that can be the cause of the error. In the next iteration, the modules or gates within the module fa003 (an instance of full_addr) are considered as potential error sources. Since the full_addr module only contains HDL statements which are not module instantiations, each statement is handled as a module. In this step, the diagnosis tool returns the HDL statement
assign sum=a1|a2|a3|a3;
   as an erroneous module. In the final step, the individual gates that implement the above assignment may be found as error sources. In this example, we are only concerned with errors at the HDL resolution (modules that are mapped to HDL statements) and do not seek to find the error at the gate or logic level.

As a final step, the error locations found by the diagnosis tools are translated back to the HDL statements that the user is familiar with. In this example, for simplicity we did not discuss how errors are found at the gate or logic level and the need to map them back to the HDL. However, this step is required in practice. For this example, the potential erroneous modules returned to the user are:
the instance fa003 of module full_addr on line 39 of the file mult_top.v
the statement
   assign sum=a1|a2|a3|a3;
on line 12 of file mult_adder.v
   other modules may be returned depending on the diagnosis technique and problem formulation (e.g., path tracing, BDD or constraint satisfiability). This information may be simply presented as above or displayed in a graphical manner. For example, a hierarchical tree structure where potential erroneous modules are highlighted with different color may provide more insight. Similarly, the potential erroneous HDL statements can be highlighted for quick identification.

The computer program of the present invention is best understood as a debugging software tool in which the method steps and/or novel diagnosis means are implemented. These method steps or diagnosis means can be incorporated into computer programming in a manner that is known, whether as a standalone computer program, or integration of the method steps and/or novel diagnosis means as features of a third party software program. The system of the present invention is best understood as a computer devices that includes or obtains the computer instructions of the aforesaid computer program.

It will be appreciated by those skilled in the art that other variations of the preferred embodiment may also be practised without departing from the scope of the invention.

What is claimed is:

1. A method for automated debugging for pre-fabricated digital synchronous hardware comprising:
(a) acquiring at least one set of capture information from at least one application of a hardware verification technique to a hardware design in a hardware design language format;
(b) applying at least one diagnosis means to the hardware design and to the at least one set of capture information to define one or more potential error sources at the logic or gate level in the hardware design; and
(c) translating the one or more potential error sources to hardware design language format, and presenting the one or more potential error sources in the hardware design language format thereby enabling automated debugging of the one or more potential error sources.

2. The method of claim 1, wherein the hardware design language format is Hardware Description Language (HDL).

3. The method of claim 2, wherein a logic-HDL map is used to translate the one or more potential error sources to the HDL-level.

4. The method of claim 3, wherein the logic-HDL map is obtained by:
(a) deconstructing the HDL statements included in the hardware design into their corresponding logic functions; and
(b) placing the logic functions in a data structure that relate the logic functions to their corresponding HDL statements.

5. The method of claim 1, wherein one or more verification tools are applied to acquire the at least one set of capture information.

6. The method of claim 5, wherein the one or more verification tools are selected from a group consisting of simulation engines, formal verification tools and semi-formal verification tools.

7. The method of claim 1, wherein the at least one diagnosis means comprises one or more of:
(a) formulation of a constraint based problem;
(b) application of a Binary Decision Diagram (BDD); or
(c) application of a simulation or path tracing method.

8. The method of claim 1 wherein the application of the diagnosis means comprises the steps of:
(a) translating the hardware design in its hardware design language format into a mathematical model;
(b) inserting error models into the mathematical model thereby enabling error locations in the hardware design to be represented; and
(c) defining a constraint to the number of active error sources at any given time and running one or more diagnosis tools iteratively until all solutions to an applicable constraint problem are found, thereby enabling the one or more potential error sources to be identified.

9. The method of claim 1, wherein the at least one diagnosis means includes formulating a diagnosis constraint satisfaction problem.

10. The method of claim 1, wherein the diagnosis constraint satisfaction problem is formulated as a Quantified Boolean Formula (QBF) problem.

11. The method of claim 10, wherein the QBF problem is solved using a QBF solver.

12. The method of claim 10, wherein the QBF problem is formulated to for one or more of (i) multiple capture and (ii) multiple time frames.

13. The method of claim 1, wherein the at least one diagnosis means includes a hierarchical diagnosis.

14. The method of claim 13, wherein the hierarchical diagnosis consists of iteratively diagnosing a plurality of hierarchical substructures of the hardware design, proceeding from higher level hierarchical substructures to lower level hierarchical structures.

15. The method of claim 14, wherein the hierarchical diagnosis continues until the hardware design has been diagnosed at the logic level.

16. A diagnosis method for automated debugging for pre-fabricated digital synchronous hardware comprising:
(a) translating hardware design in its hardware design language format into a mathematical model;
(b) inserting error models into the mathematical model thereby enabling error locations in the hardware design to be represented; and
(c) formulating a diagnosis constraint satisfaction problem as a Quantified Boolean Formula (QBF) problem by defining a constraint to the number of active error sources at any given time, wherein the QBF problem is formulated for one or more of (i) multiple capture and (ii) multiple time frames.

17. A diagnosis method for automated debugging for pre-fabricated digital synchronous hardware comprising:
(a) iteratively applying one or more diagnosis tools consisting of formulating a constraint based problem, application of a Binary Decision Diagram (BDD), or application of a simulation or path tracing method, to a plurality of hierarchical substructures of the hardware design, proceeding from higher level hierarchical substructures to lower level hierarchical structures.

18. A system for automated debugging for pre-fabricated digital synchronous hardware comprising:
(a) a computer;
(b) a computer application linked to the computer, the computer application being operable to provide instructions to the computer that enable the computer to:
(i) acquire at least one set of capture information from at least one application of a hardware verification technique to a hardware design in a hardware design language format;
(ii) apply at least one diagnosis means to the hardware design and to the at least one set of capture information to define one or more potential error sources at the logic or gate level in the hardware design; and
(iii) translate the one or more potential error sources to a hardware design language format, and presenting the one or more potential error sources in the hardware design language format thereby enabling automated debugging of the one or more potential error sources.

19. The system of claim 18, wherein the hardware design language format is Hardware Description Language (HDL).

20. The system of claim 19, wherein a logic-HDL map is used to translate the one or more potential error sources to the HDL-level.

21. The system of claim 20, wherein the logic-HDL map is obtained by:
(a) deconstructing the HDL statements included in the hardware design into their corresponding logic functions; and
(b) placing the logic functions in a data structure that relate the logic functions to their corresponding HDL statements.

22. The system of claim 18, wherein one or more verification tools are applied to acquire the at least one set of capture information.

23. The system of claim 22, wherein the one or more verification tools are selected from a group consisting of simulation engines, formal verification tools and semi-formal verification tools.

24. The system of claim 18 wherein the application of the diagnosis means comprises the steps of:
(a) translating the hardware design in its hardware design language format into a mathematical model;
(b) inserting error models into the mathematical model thereby enabling error locations in the hardware design to be represented; and
(c) defining a constraint to the number of active error sources at any given time and running one or more diagnosis tools iteratively until all solutions to an applicable constraint problem are found, thereby enabling the one or more potential error sources to be identified.

25. The system of claim 18, wherein the at least one diagnosis means includes formulating a diagnosis constraint satisfaction problem.

26. The system of claim 18, wherein the diagnosis constraint satisfaction problem is formulated as a Quantified Boolean Formula (QBF) problem.

27. The system of claim 26, wherein the QBF problem is solved using a QBF solver.

28. The system of claim 26, wherein the QBF problem is formulated to for one or more of (i) multiple capture and (ii) multiple time frames.

29. The system of claim 18, wherein the at least one diagnosis means includes a hierarchical diagnosis.

30. The system of claim 29, wherein the hierarchical diagnosis consists of iteratively diagnosing a plurality of hierarchical substructures of the hardware design until the required hierarchical substructure level of the hardware design has been diagnosed at the logic level.

31. A computer program product for automated debugging for pre-fabricated digital synchronous hardware, the computer program product for use on a server computer, the computer program product comprising:
(a) a computer usable medium;
(b) computer readable program code recorded or storable in the computer usable medium, the computer readable program code defining a debugging application on the server computer that is operable on the server computer to:
(i) acquire at least one set of capture information from at least one application of a hardware verification technique to a hardware design in a hardware design language format;
(ii) apply at least one diagnosis means to the hardware design and to the at least one set of capture information to define one or more potential error sources at the logic or gate level in the hardware design; and
(iii) translate the one or more potential error sources to hardware design language format, and presenting the one or more potential error sources in the hardware design language format thereby enabling automated debugging of the one or more potential error sources.
